(19) United States
(12) Patent Application Publication
(10) Pub. No.: US 2026/0230679 A1
(43) Pub. Date: Aug. 6, 2026

(54) INFORMATION PRESENTATION METHOD AND APPARATUS, AND ELECTRONIC DEVICE AND COMPUTER-READABLE MEDIUM

(71) Applicant: Beijing Zitiao Network Technology Co., Ltd., Beijing (CN)

(72) Inventors: Di WANG, Beijing (CN); Qiannan DING, Beijing (CN)

(21) Appl. No.: 19/150,177

(22) PCT Filed: May 23, 2024
(86) PCT No.: PCT/CN2024/094922

§ 371 Date: Jul. 22, 2025

(30) Foreign Application Priority Data
May 26, 2023 (CN) 202310610683.1

(51) Int. Cl. H04N 21/478; H04N 21/431; H04N 21/472; H04N 21/84

(52) U.S. Cl. CPC H04N 21/47815; H04N 21/4312; H04N 21/472; H04N 21/84

(57) ABSTRACT

The present disclosure provides an information display method and apparatus, an electronic device, and a computer-readable medium. The method includes: displaying a video display page in response to a preset operation; and displaying resource distribution description information on the video display page, displaying video data on the video display page, and displaying object description information corresponding to the video data on the video display page, wherein the resource distribution description information is updated as display state characterization data of the video display page changes, and the object description information is updated as the resource distribution description information changes. This effectively simplifies the user's operation of viewing the information about the object, thereby improving user experience.

The present application claims priority to Chinese Patent Application No. 202310610683.1, filed on May 26, 2023, which is incorporated herein by reference in its entirety as a part of the present application.

### TECHNICAL FIELD

The present application relates to an information display method and apparatus, an electronic device, and a computer-readable medium.

### BACKGROUND

In some application scenarios, a user may know information (such as a resource value) about a certain object (such as a commodity or a service) with a terminal device, so that the user can subsequently decide, based on the information, whether to buy the object.

As an example, in some cases, a user may trigger some operations for certain video data (such as a live video) to view information about a certain object, but in this way, the user usually needs to trigger multiple interaction operations to view information about the object. This affects user experience.

### SUMMARY

The present application provides an information display method and apparatus, an electronic device, and a computer-readable medium, which can improve user experience.

To achieve the above objective, the present application provides the following technical solutions.

The present application provides an information display method. The method includes:
displaying a video display page in response to a preset operation; and
displaying resource distribution description information on the video display page, displaying video data on the video display page, and displaying object description information corresponding to the video data on the video display page, where the resource distribution description information is updated as display state characterization data of the video display page changes, and the object description information is updated as the resource distribution description information changes.

In one possible implementation, the video display page is used to sequentially display at least one piece of video data in full screen;
the at least one piece of video data includes first-type video data and second-type video data;
the first-type video data is video data associated with a first object; and
the second-type video data is generated based on image data associated with a second object.

In one possible implementation, the first-type video data includes live video data associated with the first object, and/or short video data associated with the first object.

In one possible implementation, the object description information is used to describe an object to be corrected that corresponds to the video data; and
the displaying object description information corresponding to the video data on the video display page includes:
displaying an object display interface corresponding to the object to be corrected on the video display page, where the object display interface displays the object description information.

In one possible implementation, the object display interface further displays at least one control; and
the method further includes:
for any of the at least one control, when a trigger operation for the control is detected, executing trigger response logic corresponding to the control.

In one possible implementation, the at least one control includes one or more of a comment control, a share control, a favorite control, an add to cart control, and a payment control.

In one possible implementation, the object description information is used to describe an object to be corrected that corresponds to the video data; and
the object to be corrected is an object, filtered from at least one object associated with the video data, that satisfies a filtering condition corresponding to the resource distribution description information;
and/or
the object description information includes a corrected resource value of the object to be corrected, the corrected resource value is determined based on a difference between a resource value before correction of the object to be corrected and a resource value to be distributed, and the resource value to be distributed is determined based on the resource distribution description information.

The present application provides an information display apparatus, including:
a first display unit configured to display a video display page in response to a preset operation; and
a second display unit configured to display resource distribution description information on the video display page, display video data on the video display page, and display object description information corresponding to the video data on the video display page, where the resource distribution description information is updated as display state characterization data of the video display page changes, and the object description information is updated as the resource distribution description information changes.

The present application provides an electronic device. The device includes: a processor and a memory, where
the memory is configured to store instructions or a computer program; and
the processor is configured to execute the instructions or computer program in the memory to cause the electronic device to perform the information display method provided in the present application.

The present application provides a computer-readable medium. The computer-readable medium stores instructions or a computer program that, when executed on a device, causes the device to perform the information display method provided in the present application.

The present application provides a computer program product, which includes a computer program carried on a non-transitory computer-readable medium. The computer program includes program code for performing the information display method provided in the present application.

### BRIEF DESCRIPTION OF DRAWINGS

To describe the technical solutions in the embodiments of the present application more clearly, the following briefly describes the accompanying drawings required for describing the embodiments. Apparently, the accompanying drawings in the following description show merely some embodiments of the present application, and a person of ordinary skill in the art may derive other drawings from these accompanying drawings without creative efforts.

FIG. 1 is a flowchart of an information display method according to an embodiment of the present application;

FIG. 2 is a schematic diagram of a video display page according to an embodiment of the present application;

FIG. 3 is a schematic diagram of a video switching procedure according to an embodiment of the present application;

FIG. 4 is a schematic diagram of an information update procedure according to an embodiment of the present application;

FIG. 5 is a schematic structural diagram of an information display apparatus according to an embodiment of the present application; and

FIG. 6 is a schematic structural diagram of an electronic device according to an embodiment of the present application.

### DETAILED DESCRIPTION

In order for those skilled in the art to better understand the solutions of the present application, the technical solutions in the embodiments of the present application will be described below clearly and completely with reference to the accompanying drawings in the embodiments of the present application. Apparently, the embodiments described are merely some rather than all of the embodiments of the present application. All other embodiments obtained by those of ordinary skill in the art based on the embodiments of the present application without creative efforts fall within the scope of protection of the present application.

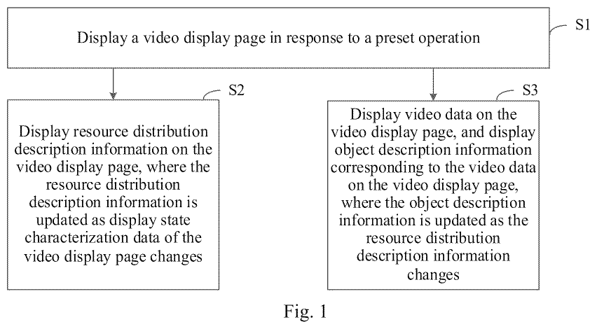

For a better understanding of the technical solution provided in the present application, the information display method provided in the present application is first described below with reference to some accompanying drawings. As shown in FIG. 1, an information display method according to an embodiment of the present application includes the following steps S1 to S3. FIG. 1 is a flowchart of an information display method according to an embodiment of the present application.

S1: Display a video display page in response to a preset operation.

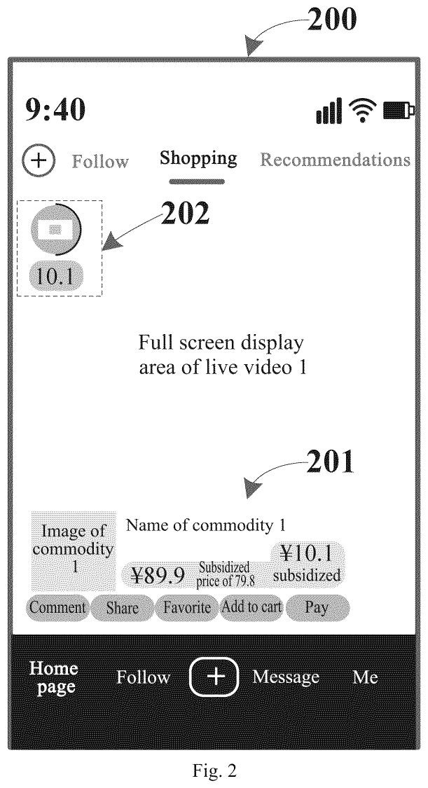

The preset operation is used to trigger a display procedure of the above-mentioned video display page, and the present application does not limit the preset operation, for example, the preset operation may be implemented using any existing or future operation that can trigger a display procedure of a video display page. As an example, when the video display page is a page 200 shown in FIG. 2, the preset operation may be a click operation for a page tab “Shopping”, or the preset operation may be an operation for switching from a page corresponding to a page tab “Follow” to a page corresponding to the page tab “Shopping”, or the preset operation may be a click operation triggered for a page entry deployed on a different page (such as a task page), to jump directly from the different page to the page corresponding to the page tab “Shopping”.

The video display page is used to display one or more pieces of video data (e.g., display some video data in full screen). For example, the video display page may be the page 200 shown in FIG. 2.

Moreover, the present application does not limit an implementation of the above-mentioned video display page. For example, the video display page may be any page (such as the page 200 shown in FIG. 2) that can be used to display video data. Based on this, in one possible implementation, the video display page may be used to display some video data (e.g., queued videos arranged in a specific order).

Based on the content in the preceding paragraph, in one possible implementation, the above-mentioned video display page may be used to sequentially display at least one piece of video data in full screen, so that the user can view the video data through the video display page. The video data is video data that can be displayed through the video display page, and the present application does not limit the video data, for example, the video data may be used to introduce one or more objects. It should be noted that the present application does not limit an implementation of the object, for example, in some application scenarios, the object may refer to a certain commodity (such as clothes) or a certain service (such as hairdressing).

In addition, the present application does not limit an implementation of the above-mentioned “at least one piece of video data”. For example, the at least one piece of video data may be implemented in queued videos arranged in a specific order, so that a user can subsequently view each piece of video data in the queued videos sequentially through the video display page.

In practice, in some application scenarios, some objects have been associated with video data in advance, while other objects are not associated with any video data. Therefore, the present application further provides one possible implementation of the above-mentioned “at least one piece of video data” so that the user can better view these objects. In this implementation, the “at least one piece of video data” may include first-type video data and second-type video data.

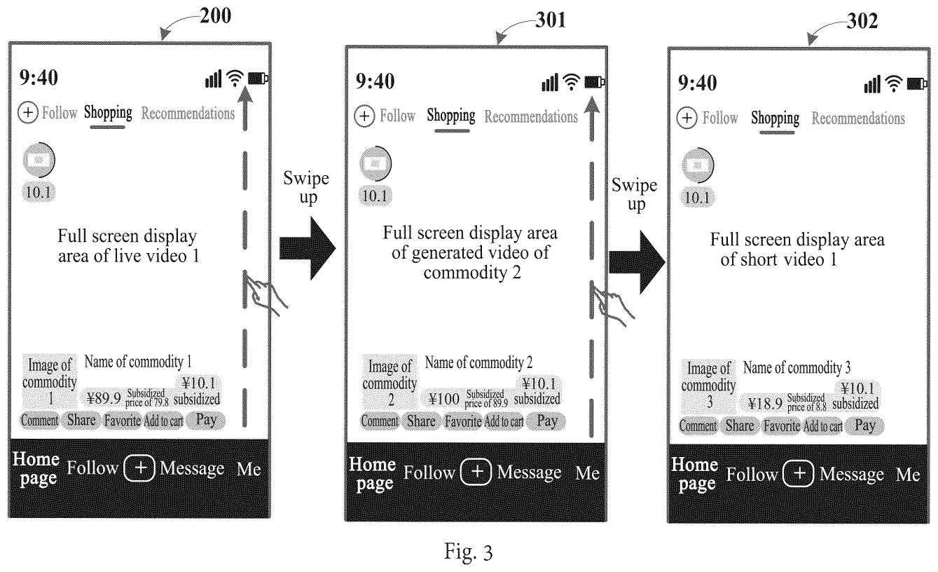

The first-type video data is video data associated with an object (such as live video data/short-form video data). It can be learned that in one possible implementation, the first-type video data may be video data associated with a first object, so that the first-type video data is used to introduce the first object. The first object is an object that has been associated with a specific piece of video data in advance, such that the first object can subsequently be introduced with the video data associated with the object. For example, when the first object is a commodity 1 shown in FIG. 2, the first-type video data may include a live video 1 as shown in FIG. 2, and because commodities to which the live video 1 relates (e.g., showcase commodities or demonstrated commodities) include the commodity 1, the live video 1 may be used to introduce the commodity 1. For another example, when the first object is a commodity 3 shown in FIG. 3, the first-type video data may include a short video 1 shown in FIG. 3, and because commodities described by the short video 1 include the commodity 3, the short video 1 may be used to introduce the commodity 3.

Based on the content in the preceding paragraph, in one possible implementation, the above-mentioned first-type video data may include live video data associated with the first object (such as the live video 1 shown in FIG. 2), so that the user may learn about the first object by using the live video data. In another possible implementation, the above-mentioned first-type video data may include short video data associated with the first object (such as the short video 1 shown in FIG. 3), so that the user may learn about the first object by using the short video data. In still another possible implementation, the first-type video data may include live video data associated with the first object and short video data associated with the first object, so that the user may learn about the first object by using the live video data and the short video data.

It should be noted that the present application does not limit an implementation of “associated” referred to in the preceding two paragraphs. For example, “associated” may be implemented using any existing or future method that can be used to establish a relationship (e.g., correspondence) between one object and one piece of video data (e.g., live video data or short video data).

The second-type video data is video data generated based on image data associated with an object, so that the second-type video data can show, in a video form, information carried by the image data. It can be learned that in one possible implementation, the second-type video data may be generated based on image data associated with a second object, so that the second-type video data is used to introduce the second object. The second object is an object that is not associated with video data, that is, video data associated with the second object cannot be found. The “image data associated with the second object” is used to describe the second object in a form of image data, and the present application does not limit an implementation of the “image data associated with the second object”. For example, the “image data associated with the second object” may include image data that has established a relationship (e.g., correspondence) with the second object in advance. As an example, when the second object is a commodity 2 shown in FIG. 3, the second-type video data may include a generated video of the commodity 2 shown in FIG. 3. Because the generated video of the commodity 2 is generated based on image data associated with the commodity 2, the generated video of the commodity 2 shows, in a video form, information carried in the image data; Also, because the image data is used to describe the commodity 2, the generated video of the commodity 2 can be used to introduce the commodity 2.

In addition, the present application does not limit the above-mentioned generation process of the second-type video data. The generation process may specifically include, for example: after the image data associated with the second object is obtained, performing video generation processing on the image data to obtain second-type video data such that the second-type video data includes the image data, so that the second-type video data is used to introduce the second object. It should be noted that the present application does not limit an implementation of the video generation processing. For example, the video generation processing may be implemented using any existing or future emerging method that can be used to convert image data into video data.

Based on the above-mentioned relevant content of the “at least one piece of video data”, it can be learned that in one possible implementation, the “at least one piece of video data” may be implemented in queued videos, and the queued videos include not only some video data (such as live video data and/or short video data) that has been associated with one or more objects in advance, but also some video data generated based on image data associated with a certain object or certain objects (such as video data that is generated based on image data associated with a certain object and that can introduce a single object, or video data that is generated based on image data associated with certain objects and that can introduce a plurality of objects) such that the queued videos include a plurality of types of video data, so that the queued videos can show more objects in a certain video display scene (such as a video display scene represented by the page corresponding to the page tab “Shopping” shown in FIG. 2), and thus introduction content of a specific type of object (such as a low-priced commodity that is not associated with a video) can be added in a certain video display scene. This enables the user to learn about more objects in the video display scene, thereby improving user experience.

It should be noted that the present application does not limit an implementation of the “queued videos” in the preceding paragraph. For example, the queued videos may be queued videos corresponding to a specific page (such as queued videos corresponding to the page corresponding to the page tab “Shopping” shown in FIG. 2).

In addition, the present application does not limit a method for determining the above-mentioned “at least one piece of video data”. For example, the method may specifically include: first obtaining queued videos determined for the above-mentioned video display page such that the queued videos include some live video data and/or some short video data; then, performing video generation processing on the image data associated with the second object according to a video structure set in advance for the queued videos to obtain new video data, so that the new video data is used to introduce the second object, and a video structure presented by the new video data is similar to the video structure set in advance for the queued videos; and finally, randomly inserting the new video data into the queued videos to obtain the “at least one piece of video data”, so that the “at least one piece of video data” includes not only some video data (such as live video data and/or short video data) that has been associated with one or more objects in advance, but also some video data generated for a certain object or certain objects. Video structures of all video data in the “at least one piece of video data” are similar, which enables the user to view the video data immersively, which is conducive to improving user experience.

Also, the present application does not limit the manner in which the above-mentioned “at least one piece of video data” is displayed on the above-mentioned video display page. For example, the “at least one piece of video data” may be automatically displayed on the video display page. That is, the video data is automatically sequentially displayed on the video display page in full screen, to automatically play the next piece of video data after one piece of video data has been played. As another example, the “at least one piece of video data” may be displayed after switching on the video display page based on the user's operations (for example, through a video switching display process shown on the page 200, a page 301, and a page 302 in FIG. 3).

Based on the above-mentioned relevant content of S1, it can be learned that for a client, after the client detects the preset operation, the video display page corresponding to the preset operation is directly displayed (e.g., the page 200 shown in FIG. 2 or FIG. 3), so that the user can subsequently view, with the video display page, some video data that introduces a certain object.

S2: Display resource distribution description information on the video display page, where the resource distribution description information is updated as display state characterization data of the video display page changes.

The resource distribution description information is used to describe a resource value that needs to be distributed (for example, a resource value of “10.1” shown in an area 202 in FIG. 2).

In addition, the above-mentioned resource distribution description information is updated as display state characterization data of the video display page changes, so that the resource distribution description information can change as the display state characterization data of the video display page constantly changes (for example, the resource distribution description information can change as a display duration of the video display page constantly increases). The display state characterization data is used to describe a current display state (such as a display duration and a number of pieces of video data already displayed) of the video display page, and the present application does not limit an implementation of the display state characterization data, for example, in some application scenarios, the display state characterization data may include the number of pieces of video data already displayed. For another example, in some other application scenarios, the display state characterization data may include the display duration. The display duration is used to describe a viewing duration of the video display page by the user, and the present application does not limit a method for determining the display duration of the video display page. For example, the method may be implemented using the following formula (1).

$$Display duration of the video display page = current moment - the moment for displaying the video display page \qquad ( 1 )$$

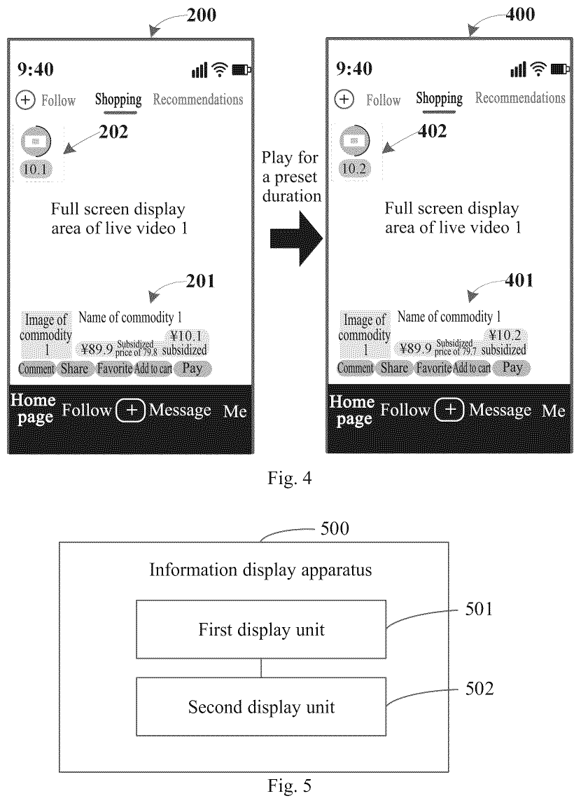

In addition, the present application does not limit an association relationship between the above-mentioned resource distribution description information and the display state characterization data of the video display page. For example, a data value carried in the resource distribution description information is positively correlated with the display state characterization data of the video display page, so that the data value carried in the resource distribution description information can increase as the display state characterization data of the video display page constantly increases. The data value carried in the resource distribution description information is a data value included in the resource distribution description information, and the present application does not limit an implementation of the “data value carried in the resource distribution description information”. For example, when the resource distribution description information includes the display state characterization data of the video display page, the “data value carried in the resource distribution description information” may include the display state characterization data. As another example, when the resource distribution description information includes a resource value to be distributed (for example, a resource value of “10.1” shown in an area 202 in FIG. 4), the “data value carried in the resource distribution description information” may include the resource value to be distributed.

Moreover, the present application does not limit an update process of the above-mentioned resource distribution description information. For example, when the resource distribution description information includes the above-mentioned display state characterization data of the video display page, the update process of the resource distribution description information is: when it is detected that the display state characterization data of the video display page changes, updating the resource distribution description information with the changed display state characterization data, so that the updated resource distribution description information includes the changed display state characterization data.

As another example, when the above-mentioned resource distribution description information includes a resource value to be distributed (for example, a resource value of “10.1” in an area 202 shown in FIG. 4), an update process of the resource distribution description information is: when it is detected that the display state characterization data of the video display page changes, first updating the resource value to be distributed (for example, to a resource value of “10.2” in an area 402 shown in FIG. 4) with the changed display state characterization data; and then updating the resource distribution description information with the updated resource value to be distributed, so that the updated resource distribution description information includes the updated resource value to be distributed. The resource value to be distributed is a resource value needed for resource distribution.

In addition, the present application does not limit the update process of the resource value to be distributed in the preceding paragraph. For example, the update process of the resource value to be distributed may be implemented using the following formula (2).

$${Y}^{′} = Y + a \times ( {T}^{′} - T ) \qquad ( 2 )$$

In the formula, Y′ represents the updated resource value to be distributed; Y represents a resource value to be distributed that is before the update; T′ represents the changed display state characterization data; T represents display state characterization data before the change; and a represents a preset growth coefficient.

As another example, the update process of the above-mentioned resource value to be distributed may specifically include: mapping the changed display state characterization data to a value directly according to a pre-defined mapping function, and determining the value as the updated resource value to be distributed. The mapping function is used to describe a mapping relationship between different durations and different values, and the present application does not limit the mapping function. For example, in some application scenarios, all objects share one mapping function. As another example, in some other application scenarios, due to different correction intensities (such as the preferential intensity or subsidy intensity) for different objects, a mapping function corresponding to each object may then be determined based on a correction intensity requirement for each object, so that the mapping function meets the correction intensity requirement, and different objects correspond to different mapping functions. This will help improve a correction effect.

Based on the relevant content of the above-mentioned resource value to be distributed, in one possible implementation, the resource value to be distributed is positively correlated with the display state characterization data of the above-mentioned video display page, so that the resource value to be distributed can become larger as the display state characterization data of the video display page increases.

In addition, the present application does not limit a location of the above-mentioned resource distribution description information on the above-mentioned video display page. For example, the resource distribution description information may be displayed in any location on the video display page. As an example, as shown in FIG. 2, when the video display page is the page 200 shown in FIG. 2, the location of the resource distribution description information on the above-mentioned video display page may be a location occupied by the area 202 shown in FIG. 2.

In addition, the present application does not limit the occupancy presented by the display process of the above-mentioned resource distribution description information for the entire display process of the above-mentioned video display page. For example, in some application scenarios, the display process of the resource distribution description information may occupy the entire display process of the video display page, that is, the resource distribution description information keeps being displayed throughout the display process of the video display page, to ensure that the resource distribution description information can be quickly viewed by the user at any one moment when viewing the video display page. This can effectively simplify the user's operation of viewing the resource distribution description information, thereby improving user experience. For another example, in some other application scenarios, the display process of the above-mentioned resource distribution description information may occupy only a portion of the entire display process of the video display page, so that the display process of the resource distribution description information can meet resource distribution stage display requirements in the application scenarios.

Furthermore, the present application does not limit an execution moment of S2 above. For example, the execution moment of S2 is the same as an execution moment of step “Display a video display page” in S1 above. That is, the above-mentioned resource distribution description information is displayed at the same time as the video display page. For another example, the execution moment of S2 may be slightly later than the execution moment of step “Display a video display page” in S1. That is, the resource distribution description information is displayed after a certain period of time since the video display page is displayed.

Based on the relevant content of S2 above, it can be learned that for a client, after the client detects a preset operation, the video display page (e.g., the page 200 shown in FIG. 2) needs to be displayed, and the resource distribution description information (such as a resource value of “10.1” shown in the area 202 in FIG. 2) also needs to be displayed on the video display page, and it needs to ensure that the resource distribution description information can be updated as the display state characterization data of the video display page changes (for example, through a resource value update procedure shown on the page 200 and a page 400 in FIG. 4), which is conducive to improving real-time performance of the resource distribution description information and thus improving user experience.

S3: Display video data on the video display page, and display object description information corresponding to the video data on the video display page, where the object description information is updated as the resource distribution description information changes.

The object description information corresponding to the video data is information about an object to which the video data relates, so that the “object description information corresponding to the video data” is used to describe an object to be corrected that corresponds to the video data. The object to be corrected is an object described by using the “object description information corresponding to the video data”, and the present application does not limit the object to be corrected. For example, the object to be corrected may be an object, filtered from at least one object associated with the video data, that satisfies a filtering condition corresponding to the above-mentioned resource distribution description information. The filtering condition may be set in advance according to an application scenario. For example, the filtering condition may specifically be as follows: The resource value preset for an object is less than a preset threshold (e.g., a low-priced commodity).

Based on the content in the preceding paragraph, when the above-mentioned video data is the live video 1 shown in FIG. 2, the object to be corrected that corresponds to the video data may be the commodity 1 shown in FIG. 2, and the object description information corresponding to the video data may include commodity information shown in the area 201 in FIG. 2 (for example, an image of the commodity 1, a name of the commodity 1, a price of the commodity 1, a subsidized price of the commodity 1, and a subsidy value given for the commodity 1).

In addition, the present application does not limit the above-mentioned “object description information corresponding to the video data”. For example, the object description information may include at least a corrected resource value of the object to be corrected. The corrected resource value is used to represent a resource value that the user actually needs to pay for the object to be corrected, and the corrected resource value is less than or equal to a resource value set in advance for the object to be corrected (for example, a price of a commodity).

In practice, for the above-mentioned corrected resource value, the corrected resource value may be determined based on the difference between the above-mentioned resource value before correction of the object to be corrected and the above-mentioned resource value to be distributed. The resource value before correction is a resource value set in advance for the object to be corrected (for example, a price of a commodity). The resource value to be distributed is a resource value needed for correction processing for the resource value before correction, and the resource value to be distributed is determined based on the above-mentioned resource distribution description information. It should be noted that, for a determination process of the resource value to be distributed, reference is made to the above-mentioned description. For brevity, details are not described herein again.

Based on the content of the preceding two paragraphs, in one possible implementation, when certain video data is displayed on the above-mentioned video display page, the resource value to be distributed may be first determined based on the resource distribution description information displayed on the video display page, so that the resource value to be distributed can represent a resource value needed for resource value correction processing to be performed for an object to be corrected that corresponds to the video data; then correction processing is performed on the resource value set in advance for the object to be corrected by using the resource value to be distributed, to obtain the corrected resource value of the object to be corrected (for example, corrected resource value of the object to be corrected=resource value set in advance for the object to be corrected-resource value to be distributed); and finally, the object description information corresponding to the video data is determined based on the corrected resource value of the object to be corrected, so that the object description information can represent at least a state of the object to be corrected that is presented in terms of resource values.

For another example, in some application scenarios, the above-mentioned “object description information corresponding to the video data” may include not only the corrected resource value of the object to be corrected (such as a subsidized price of a certain commodity), may further include the resource value before correction of the object to be corrected (for example, a price of a certain commodity), the above-mentioned resource value to be distributed (such as a subsidy value for a certain commodity), the image data corresponding to the object to be corrected, and one or more items of information in a name of the object to be corrected, so that the “object description information corresponding to the video data” can more comprehensively describe the object to be corrected.

In practice, because the above-mentioned resource distribution description information is not constant, in order to ensure accuracy of the above-mentioned “object description information corresponding to the video data”, the “object description information corresponding to the video data” may be updated as the resource distribution description information changes (for example, an update process shown in an area 201 and an area 401 in FIG. 4), which is conducive to improving the real-time performance of the “object description information corresponding to the video data” and thus improving user experience. It should be noted that an update process of the “object description information corresponding to the video data” is similar to the above-mentioned determination process of the “object description information corresponding to the video data”. For brevity, details are not described herein again.

In addition, the present application does not limit display timing of the above-mentioned “object description information corresponding to the video data”. For example, the display timing of the “object description information corresponding to the video data” is the same as display timing of the video data on the above-mentioned video display page. That is, when the video data is displayed in full screen on the video display page, the object description information corresponding to the video data may also start to be displayed. It should be noted that the present application does not limit the display timing of the video data on the above-mentioned video display page, and display timing of different video data on the above-mentioned video display page is different.

In addition, the present application does not limit the occupancy presented by the display process of the above-mentioned “object description information corresponding to the video data” for the entire display process of the video data. For example, the display process of the “object description information corresponding to the video data” may occupy the entire display stage of the video data, to ensure that the object description information of the object to be corrected that corresponds to the video data can be quickly viewed by the user at any one moment when viewing the video data. This can effectively simplify the user's operation of viewing the object to be corrected, thereby improving the user experience.

Moreover, the present application does not limit an implementation of the step “display object description information corresponding to the video data on the video display page” in the above-mentioned S3. For example, the step may be implemented in any existing or future method that can be used to display information about an object.

In practice, to better improve user experience, the present application further provides a possible implementation of the above-mentioned S3, which may specifically include: displaying the video data on the above-mentioned video display page, and displaying, on the video display page, an object display interface corresponding to the object to be corrected that is associated with the video data, where the object display interface displays the above-mentioned object description information. The object display interface is used to display information about the object to be corrected, and the present application does not limit an implementation of the object display interface. For example, the object display interface may be implemented using any existing or future interface that can carry information about an object (such as a commodity card shown in the area 201 in FIG. 2).

Based on the content in the preceding paragraph, in one possible implementation, certain video data (for example, the live video 1 shown in FIG. 2) is displayed on the above-mentioned video display page (for example, the page 200 shown in FIG. 2), the object display interface (such as the commodity card shown in the area 201 in FIG. 2) corresponding to the object to be corrected that is associated with the video data may also be displayed on the video display page, so that the object display interface is used to carry and display the object description information (such as the image of the commodity 1, the name of commodity 1, the price of the commodity 1, the subsidized price of the commodity 1, and the subsidy value given for the commodity 1) of the object to be corrected, so that the user can learn about the information about the object to be corrected through the object display interface. This can effectively simplify the user's operation of viewing the object to be corrected, thereby improving user experience.

In practice, to better improve user experience, the present application further provides one possible implementation of the above-mentioned object display interface. In this implementation, the object display interface displays not only the object description information of the above-mentioned object to be corrected, but also at least one control, so that the at least one control can meet some operating needs of the user for the object to be corrected (such as favorite, pay, add to cart, and other operating needs).

In addition, the present application does not limit an implementation of the “at least one control” in the preceding paragraph. For example, the at least one control may include one or more of a comment control, a share control, a favorite control, an add to cart control, and a payment control. The comment control is used to provide a comment input function and/or a comment viewing function, so that the user can enter and/or view, using the comment control, comment information for the above-mentioned object to be corrected. The share control is used to provide an information sharing function, so that the user may share, using the share control, the object to be corrected with others. The favorite control is used to provide an information favorite function, so that the user may favorite, using the favorite control, the object to be corrected. The add to cart control is used to provide an add to cart function, so that the user may add the object to be corrected to a cart by using the add to cart control. The payment control is used to provide a payment function, so that the user may complete, using the payment control, a payment procedure for the object to be corrected. It should be noted that the present application does not limit implementations of the comment control, the share control, the favorite control, the add to cart control, and the payment control.

Based on the content of the preceding two paragraphs, when the above-mentioned video display page displays the above-mentioned object display interface, and the object display interface further displays at least one control, the present application can implement an interaction process shown in step 11 below by using the video display page.

Step 11: For any of the at least one control, when a trigger operation for the control is detected, execute trigger response logic corresponding to the control.

Trigger response logic corresponding to a control is trigger response logic set in advance for the control, so that the trigger response logic is used to implement the interaction procedure corresponding to the control. For example, when the control is a comment control, the trigger response logic corresponding to the control may be used to implement a comment input procedure and/or a comment viewing procedure; when the control is a share control, the trigger response logic corresponding to the control may be used to implement a share procedure; when the control is a favorite control, the trigger response logic corresponding to the control may be used to implement a favorite procedure; when the control is an add to cart control, the trigger response logic corresponding to the control may be used to implement an add to cart procedure; and when the control is a payment control, the trigger response logic corresponding to the control may be used to implement a payment procedure. It should be noted that the present application does not limit implementations of the comment input procedure, the comment viewing procedure, the share procedure, the favorite procedure, the add to cart procedure, and the payment procedure.

In addition, for the trigger response logic corresponding to the above-mentioned controls, if the trigger response logic relates to a display procedure of a new page, the new page may be directly displayed on the above-mentioned video display page in a certain form (for example, a drop-down page), so that the trigger response logic can be completed without leaving the video display page. This can effectively avoid defects caused by leaving the video display page, thereby improving user experience.

Based on the relevant content of the above-mentioned at least one control, in one possible implementation, when the above-mentioned video display page displays certain video data and an object display interface corresponding to an object to be corrected that is associated with the video data, the object display interface may not only display information about the object to be corrected, but may also display controls, so that the user can quickly complete, with the controls, some operations (such as favorite, pay, and add to cart) for the object to be displayed, thereby improving user experience.

Based on the relevant content of the above-mentioned S1 to S3, for the information display method provided in the embodiments of the present application, when a video display page (such as a page tabbed by “Shopping”) is displayed, resource distribution description information is displayed on the video display page, and video data and object description information corresponding to the video data are also displayed on the video display page, so that the object description information is used to describe an object to which the video data relates. In this way, the user can directly view information about the object on the video display page. This can effectively simplify the user's operation of viewing the information about the object, thereby improving user experience.

In addition, because the above-mentioned object description information is updated as the resource distribution description information changes, and the resource distribution description information is updated as the display state characterization data (such as the display duration) of the video display page changes, so that the object description information is constantly updated as the display state characterization data of the video display page is constantly increased. In this way, the object description information can accurately describe a state of an object to which the above-mentioned video data relates at different moments, which is conducive to improving real-time performance of the object description information and thus better improving user experience.

In addition, the present application does not limit an execution body of the information display method provided in the embodiments of the present application, for example, the information display method provided in the embodiments of the present application may be applied to a terminal device. For another example, the information display method provided in the embodiments of the present application may also be implemented using a data interaction process between a terminal device and a server. The terminal device may be a smartphone, a computer, a personal digital assistant (PDA), a tablet computer, etc. The server may be a stand-alone server, a cluster server, or a cloud server.

Based on the information display method provided in the embodiments of the present application, an embodiment of the present application further provides an information display apparatus, which is explained and described below with reference to FIG. 5. Herein, FIG. 5 is a schematic structural diagram of an information display apparatus according to an embodiment of the present application. It should be noted that for the technical details of the information display apparatus provided in this embodiment of the present application, refer to the relevant content of the information display method described above.

As shown in FIG. 5, an information display apparatus 500 provided in the embodiment of the present application includes:
a first display unit 501 configured to display a video display page in response to a preset operation; and
a second display unit 502 configured to display resource distribution description information on the video display page, display video data on the video display page, and display object description information corresponding to the video data on the video display page, where the resource distribution description information is updated as display state characterization data of the video display page changes, and the object description information is updated as the resource distribution description information changes.

In one possible implementation, the video display page is used to sequentially display at least one piece of video data in full screen;
the at least one piece of video data includes first-type video data and second-type video data;
the first-type video data is video data associated with a first object; and
the second-type video data is generated based on image data associated with a second object.

In one possible implementation, the first-type video data includes live video data associated with the first object, and/or short video data associated with the first object.

In one possible implementation, the object description information is used to describe an object to be corrected that corresponds to the video data; and
the second display unit 502 is specifically configured to: display an object display interface corresponding to the object to be corrected on the video display page, where the object display interface displays the object description information.

In one possible implementation, the object display interface further displays at least one control; and
the information display apparatus 500 further includes:
a logic execution unit configured to: for any of the at least one control, when a trigger operation for the control is detected, execute trigger response logic corresponding to the control.

In one possible implementation, the at least one control includes one or more of a comment control, a share control, a favorite control, an add to cart control, and a payment control.

In one possible implementation, the object description information is used to describe an object to be corrected that corresponds to the video data; and
the object to be corrected is an object, filtered from at least one object associated with the video data, that satisfies a filtering condition corresponding to the resource distribution description information;
and/or
the object description information includes a corrected resource value of the object to be corrected, the corrected resource value is determined based on a difference between a resource value before correction of the object to be corrected and a resource value to be distributed, and the resource value to be distributed is determined based on the resource distribution description information.

Based on the relevant content of the above information display apparatus 500, for the information display apparatus 500 provided in this embodiment of the present application, when a video display page (such as a page tabbed by “Shopping”) is being displayed, resource distribution description information is displayed on the video display page, and video data and object description information corresponding to the video data are also displayed on the video display page, so that the object description information is used to describe an object to which the video data relates. In this way, the user can directly view information about the object on the video display page. This can effectively simplify the user's operation of viewing the information about the object, thereby improving user experience.

In addition, because the above-mentioned object description information is updated as the resource distribution description information changes, and the resource distribution description information is updated as the display state characterization data of the video display page changes, so that the object description information is constantly updated as the display state characterization data of the video display page is constantly increased. In this way, the object description information can accurately describe a state of an object to which the above-mentioned video data relates at different moments, which is conducive to improving real-time performance of the object description information and thus better improving user experience.

In addition, an embodiment of the present application further provides an electronic device. The device includes a processor and a memory, where the memory is configured to store instructions or a computer program; and the processor is configured to execute the instructions or computer program in the memory to cause the electronic device to perform any implementation of the information display method provided in the embodiments of the present application.

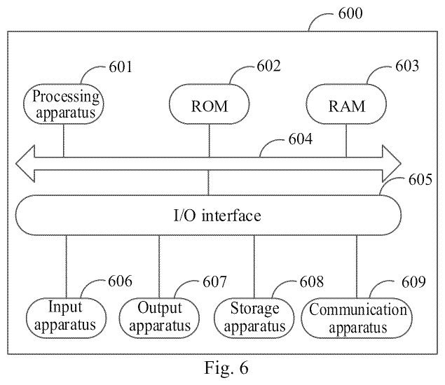

Reference is made to FIG. 6, which is a schematic structural diagram of an electronic device 600 suitable for implementing an embodiment of the present disclosure. A terminal device in this embodiment of the present disclosure may include, but is not limited to, mobile terminals such as a mobile phone, a notebook computer, a digital broadcast receiver, a personal digital assistant (PDA), a tablet computer (portable Android device, PAD), a portable media player (PMP), and a vehicle-mounted terminal (e.g., a vehicle navigation terminal), and fixed terminals such as a digital TV and a desktop computer. The electronic device shown in FIG. 6 is merely an example, and shall not impose any limitation on the function and scope of use of the embodiments of the present disclosure.

As shown in FIG. 6, the electronic device 600 may include a processing apparatus (for example, a central processing unit or a graphics processing unit) 601 that may perform a variety of appropriate actions and processing in accordance with a program stored in a read-only memory (ROM) 602 or a program loaded from a storage apparatus 608 into a random-access memory (RAM) 603. The RAM 603 further stores various programs and data required for operations of the electronic device 600. The processing apparatus 601, the ROM 602, and the RAM 603 are connected to one another through a bus 604. An input/output (I/O) interface 605 is also connected to the bus 604.

Generally, the following apparatuses may be connected to the I/O interface 605: an input apparatus 606 including, for example, a touchscreen, a touchpad, a keyboard, a mouse, a camera, a microphone, an accelerometer, and a gyroscope; an output apparatus 607 including, for example, a liquid crystal display (LCD), a speaker, and a vibrator; the storage apparatus 608 including, for example, a magnetic tape and a hard disk; and a communication apparatus 609. The communication apparatus 609 may allow the electronic device 600 to perform wireless or wired communication with other devices to exchange data. Although FIG. 6 shows the electronic device 600 having various apparatuses, it should be understood that it is not required to implement or have all of the shown apparatuses. It may be an alternative to implement or have more or fewer apparatuses.

In particular, according to an embodiment of the present disclosure, the process described above with reference to the flowchart may be implemented as a computer software program. For example, an embodiment of the present disclosure includes a computer program product, which includes a computer program carried on a non-transitory computer-readable medium, where the computer program includes program code for performing the method shown in the flowchart. In such an embodiment, the computer program may be downloaded and installed from a network through the communication apparatus 609, installed from the storage apparatus 608, or installed from the ROM 602. When the computer program is executed by the processing apparatus 601, the above-mentioned functions defined in the method of the embodiment of the present disclosure are performed.

The electronic device according to this embodiment of the present disclosure and the method according to the above embodiments belong to the same inventive concept. For the technical details not exhaustively described in this embodiment, reference may be made to the above embodiments, and this embodiment and the above embodiments have the same beneficial effects.

An embodiment of the present application further provides a computer-readable medium. The computer-readable medium stores instructions or a computer program that, when executed on a device, cause the device to perform any implementation of the information display method provided in the embodiments of the present application.

It should be noted that the above computer-readable medium described in the present disclosure may be a computer-readable signal medium, a computer-readable storage medium, or any combination thereof. The computer-readable storage medium may be, for example but not limited to, electric, magnetic, optical, electromagnetic, infrared, or semiconductor systems, apparatuses, or devices, or any combination thereof. More specific examples of the computer-readable storage medium may include, but are not limited to: an electrical connection having one or more wires, a portable computer magnetic disk, a hard disk, a random-access memory (RAM), a read-only memory (ROM), an erasable programmable read-only memory (EPROM) (or a flash memory), an optical fiber, a portable compact disc read-only memory (CD-ROM), an optical storage device, a magnetic storage device, or any suitable combination thereof. In the present disclosure, the computer-readable storage medium may be any tangible medium containing or storing a program which may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may further be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to: electric wires, optical cables, radio frequency (RF), etc., or any suitable combination thereof.

In some implementations, a client or a server may perform communication by using any currently known or future-developed network protocol such as the Hypertext Transfer Protocol (HTTP), and may interconnect with digital data communication (e.g., a communication network) in any form or medium. Examples of the communication network include a local area network (“LAN”), a wide area network (“WAN”), an internetwork (for example, the Internet), a peer-to-peer network (for example, an ad hoc peer-to-peer network), and any currently known or future-developed network.

The above computer-readable medium may be contained in the above electronic device. Alternatively, the computer-readable medium may exist independently, without being assembled into the electronic device.

The above computer-readable medium carries one or more programs that, when executed by the electronic device, enable the electronic device to perform the above method.

Computer program code for performing operations of the present disclosure can be written in one or more programming languages or a combination thereof, where the programming languages include but are not limited to object-oriented programming languages, such as Java, Smalltalk, and C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the case of the remote computer, the remote computer may be connected to the computer of the user through any kind of network, including a local area network (LAN) or a wide area network (WAN), or may be connected to an external computer (for example, connected through the Internet with the aid of an Internet service provider).

The flowchart and block diagram in the accompanying drawings illustrate the possibly implemented architecture, functions, and operations of the system, method, and computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the accompanying drawings. For example, two blocks shown in succession can actually be performed substantially in parallel, or they can sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The related units described in the embodiments of the present disclosure may be implemented by software, or may be implemented by hardware. The name of the unit/module does not constitute a limitation on the unit itself under certain circumstances.

The functions described herein above may be performed at least partially by one or more hardware logic components. For example, without limitation, exemplary types of hardware logic components that may be used include: a field programmable gate array (FPGA), an application-specific integrated circuit (ASIC), an application-specific standard product (ASSP), a system-on-chip (SOC), a complex programmable logic device (CPLD), and the like.

In the context of the present disclosure, a machine-readable medium may be a tangible medium that may contain or store a program used by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random-access memory (RAM), a read-only memory (ROM), an erasable programmable read-only memory (EPROM) (or a flash memory), an optic fiber, a portable compact disc read-only memory (CD-ROM), an optical storage device, a magnetic storage device, or any suitable combination thereof.

It should be noted that the various embodiments in this specification are described in a progressive manner, and each embodiment focuses on the differences from other embodiments. The same or similar parts between the various embodiments may be referenced to each other. For the system or apparatus disclosed in this embodiment, since it corresponds to the method disclosed in the embodiments, the description is relatively simple, and for the related parts, reference may be made to the description of the method.

It should be understood that, in the present application, “at least one” means one or more, and “a plurality of” means two or more. The term “and/or” is used to describe an association relationship between associated objects, and indicates that three relationships may exist, for example, A and/or B may indicate that: only A exists, only B exists, and both A and B exist, where A or B may be singular or plural. The character “/” generally indicates an “or” relationship between the associated objects. “At least one of the following” or similar expressions refers to any combination of these items, including any combination of single items or plural items. For example, at least one of a, b, or c may indicate: a, b, c, “a and b”, “a and c”, “b and c”, or “a and b and c”, where a, b, or c may be singular or plural.

It should also be noted that, herein, relative terms such as “first” and “second” are only used to distinguish one entity or operation from another entity or operation, and do not necessarily require or imply that such an actual relationship or order exists between these entities or operations. Moreover, the terms “include” and “include”, or any of their variants are intended to cover a non-exclusive inclusion, so that a process, method, article, or device that includes a list of elements not only includes those elements but also includes other elements that are not expressly listed, or further includes elements inherent to such process, method, article, or device. In the absence of more restrictions, an element defined by “including/including a/an . . . ” does not exclude another identical element in a process, method, article, or device that includes the element.

The steps of the method or algorithm described in conjunction with the embodiments disclosed herein may be implemented directly in hardware, in a software module executed by a processor, or in a combination of the two. The software module may be disposed in a random-access memory (RAM), a memory, a read-only memory (ROM), an electrically programmable ROM, an electrically erasable programmable ROM, a register, a hard disk, a removable disk, a CD-ROM, or any other form of storage medium known in the art.

With respect to the above description of the disclosed embodiments, those skilled in the art could implement or use the present application. Various modifications to these embodiments are apparent to those skilled in the art, and the general principle defined herein may be practiced in other embodiments without departing from the spirit or scope of the present application. Therefore, the present application is not limited to the embodiments described herein but is to be accorded with the broadest scope consistent with the principle and novel features disclosed herein.

1. An information display method, comprising:
displaying a video display page in response to a preset operation; and
displaying resource distribution description information on the video display page, displaying video data on the video display page, and displaying object description information corresponding to the video data on the video display page, wherein the resource distribution description information is updated as display state characterization data of the video display page changes, and the object description information is updated as the resource distribution description information changes.

2. The method according to claim 1, wherein the video display page is used to sequentially display at least one piece of video data in full screen;
the at least one piece of video data comprises first-type video data and second-type video data;
the first-type video data is video data associated with a first object; and
the second-type video data is generated based on image data associated with a second object.

3. The method according to claim 2, wherein the first-type video data comprises live video data associated with the first object, and/or short video data associated with the first object.

4. The method according to claim 1, wherein the object description information is used to describe an object to be corrected that corresponds to the video data; and
the displaying object description information corresponding to the video data on the video display page comprises:
displaying an object display interface corresponding to the object to be corrected on the video display page, wherein the object display interface displays the object description information.

5. The method according to claim 4, wherein the object display interface further displays at least one control; and
the method further comprises:
for any of the at least one control, when a trigger operation for the control is detected, executing trigger response logic corresponding to the control.

6. The method according to claim 5, wherein the at least one control comprises one or more of a comment control, a share control, a favorite control, an add to cart control, and a payment control.

7. The method according to claim 1, wherein the object description information is used to describe an object to be corrected that corresponds to the video data; and
the object to be corrected is an object, filtered from at least one object associated with the video data, that satisfies a filtering condition corresponding to the resource distribution description information;
and/or
the object description information comprises a corrected resource value of the object to be corrected, the corrected resource value is determined based on a difference between a resource value before correction of the object to be corrected and a resource value to be distributed, and the resource value to be distributed is determined based on the resource distribution description information.

8. An information display apparatus, comprising:
a processor, and
a non-transitory memory with instructions stored thereon,
wherein the instructions upon execution by the processor, cause the processor to:
display a video display page in response to a preset operation; and
display resource distribution description information on the video display page, display video data on the video display page, and display object description information corresponding to the video data on the video display page, wherein the resource distribution description information is updated as display state characterization data of the video display page changes, and the object description information is updated as the resource distribution description information changes.

9. An electronic device, comprising: a processor and a memory, wherein
the memory is configured to store instructions or a computer program; and
the processor is configured to execute the instructions or computer program stored in the memory, to cause the electronic device to perform the method according to claim 1.

10. A non-transitory computer-readable medium storing instructions that cause a processor to:
display a video display page in response to a preset operation; and
display resource distribution description information on the video display page, display video data on the video display page, and display object description information corresponding to the video data on the video display page, wherein the resource distribution description information is updated as display state characterization data of the video display page changes, and the object description information is updated as the resource distribution description information changes.

11. The apparatus according to claim 8, wherein the video display page is used to sequentially display at least one piece of video data in full screen;
the at least one piece of video data comprises first-type video data and second-type video data;
the first-type video data is video data associated with a first object; and
the second-type video data is generated based on image data associated with a second object.

12. The apparatus according to claim 11, wherein the first-type video data comprises live video data associated with the first object, and/or short video data associated with the first object.

13. The apparatus according to claim 8, wherein the object description information is used to describe an object to be corrected that corresponds to the video data; and
the displaying object description information corresponding to the video data on the video display page comprises:
displaying an object display interface corresponding to the object to be corrected on the video display page, wherein the object display interface displays the object description information.

14. The apparatus according to claim 13, wherein the object display interface further displays at least one control; and
the instructions further cause the processor to:
for any of the at least one control, when a trigger operation for the control is detected, execute trigger response logic corresponding to the control.

15. The apparatus according to claim 14, wherein the at least one control comprises one or more of a comment control, a share control, a favorite control, an add to cart control, and a payment control.

16. The apparatus according to claim 8, wherein the object description information is used to describe an object to be corrected that corresponds to the video data; and
the object to be corrected is an object, filtered from at least one object associated with the video data, that satisfies a filtering condition corresponding to the resource distribution description information;
and/or
the object description information comprises a corrected resource value of the object to be corrected, the corrected resource value is determined based on a difference between a resource value before correction of the object to be corrected and a resource value to be distributed, and the resource value to be distributed is determined based on the resource distribution description information.

17. The non-transitory computer-readable medium according to claim 10, wherein the video display page is used to sequentially display at least one piece of video data in full screen;
the at least one piece of video data comprises first-type video data and second-type video data;
the first-type video data is video data associated with a first object; and
the second-type video data is generated based on image data associated with a second object.

18. The non-transitory computer-readable medium according to claim 17, wherein the first-type video data comprises live video data associated with the first object, and/or short video data associated with the first object.

19. The non-transitory computer-readable medium according to claim 10, wherein the object description information is used to describe an object to be corrected that corresponds to the video data; and
the displaying object description information corresponding to the video data on the video display page comprises:
displaying an object display interface corresponding to the object to be corrected on the video display page, wherein the object display interface displays the object description information.

20. The non-transitory computer-readable medium according to claim 19, wherein the object display interface further displays at least one control; and
the instructions further cause the processor to:
for any of the at least one control, when a trigger operation for the control is detected, execute trigger response logic corresponding to the control.
